(19) United States
(12) Patent Application Publication
(10) Pub. No.: US 2014/0066024 A1
(43) Pub. Date: Mar. 6, 2014

(54) METHOD OF NOTIFYING OF AN INCOMING COMMUNICATION IN A MOBILE COMMUNICATION TERMINAL, AND A MOBILE COMMUNICATION TERMINAL AND A SHORT RANGE WIRELESS COMMUNICATION DEVICE FOR THE SAME

(71) Applicant: Samsung Electronics Co., Ltd., Gyeonggi-do (KR)

(72) Inventors: Kyong-Hun LEE, Gyeongsangbuk-do (KR); Min-Jee KANG, Seoul (KR); Hyo-Moon JEONG, Gyeongsangbuk-do (KR)

(73) Assignee: Samsung Electronics Co., Ltd., Gyeonggi-do (KR)

(21) Appl. No.: 14/010,920

(22) Filed: Aug. 27, 2013

(30) Foreign Application Priority Data
Aug. 28, 2012 (KR) 10-2012-0094017

(51) Int. Cl. H04W 68/00; H04W 4/00

(52) U.S. Cl. CPC H04W 68/00; H04W 4/008
USPC 455/412.2

(57) ABSTRACT

A method notifies of an incoming call or message in a mobile communication terminal, and using a short range wireless communication device. The mobile communication terminal generates a message having the information exchange format by encoding a message including incoming notifying information related to the incoming call or message to have an information exchange format and by adding an incoming notifying parameter set to be in a notification supporting state, and transmits the message to a short range wireless communication device set as an incoming notifying device through the short range wireless communication. The short range wireless communication device receives a message having an information exchange format, decodes the message, and displays information decoded from the message through the display by an incoming notifying popup, when an incoming notifying parameter is set to be in a notification supporting state.

### CLAIM OF PRIORITY

This application claims, pursuant to 35 U.S.C. §119(a), priority to and the benefit of the earlier filing date of Korean Application Serial No. 10-2012-0094017, which was filed in the Korean Intellectual Property Office on Aug. 28, 2012, the entire contents of which is hereby incorporated by reference.

### BACKGROUND

1. Field of the Invention

The present disclosure relates generally to a mobile communication terminal, and more particularly, to a method of notifying a user of the incoming of a call or a message, and a mobile communication terminal and a short range wireless communication device for the same.

2. Description of the Related Art

Mobile communication terminals in the prior art such as a mobile phone, a smart phone and the like notify a user of an incoming communication (hereafter referred to as an “incoming”) when there is the incoming of a call or a message such as a Short Message Service (SMS), a Multi-Media Message Service (MMS), or an Instant Message (IM). In general, the notification of the incoming is performed by at least one of a vibration, a sound, and a display for outputting the notification.

A user of the mobile communication terminal in the prior art frequently puts the mobile communication terminal into a bag carried by the user or near the user instead of directly carrying the mobile communication terminal while the user does not use the mobile communication terminal. In particular, when the mobile communication terminal is a large-sized mobile communication terminal such as a tablet phone corresponding to a combination of a tablet computer and a mobile phone, it is difficult for the user to grasp the mobile communication terminal with his/her hand or put the mobile communication terminal into a pocket, so that the above case where the user does not directly carry the mobile communication terminal may occur more frequently. In this case, the user may not recognize the notification of the incoming of the mobile communication terminal.

Meanwhile, the user of the mobile communication terminal in the prior art may carry various types of devices together including the mobile communication terminal For example, the user may carry the mobile phone or a handheld smart phone in a state where the user puts the tablet phone near the user or into the bag carried by the user. Further, the user of the mobile communication terminal may further use a fixed device such as a desktop computer, and may further carry a mobile device such as a laptop computer, a tablet computer, a digital camera, a Personal Digital Assistant (PDA), or a Portable Multimedia Player (PMP).

In consideration of such points, when the mobile communication terminal put near the user or into the bag carried by the user has the incoming, if the user can be notified of the incoming through another device being used or carried by the user, the user may easily recognize the notification of the incoming. For example, there may be a case where the incoming of the mobile communication terminal is notified to the user through another device of the user by using short range wireless communication technology such as Bluetooth.

However, a dedicated profile by which one device notifies the user of the incoming through another device by using the short range wireless communication has not yet been proposed in the prior art. A profile defines a type of protocol which should be used for each particular application when a short range wireless communication application is implemented, and a structure and a usage of the protocol. It is not efficient to define and use a new profile in order to notify the user of the incoming.

### SUMMARY

Accordingly, the present invention provides an incoming notifying method by which a mobile communication terminal can notify of the incoming through another device by using a message based on an information exchange format already defined for short range wireless communication, and the mobile communication terminal and a short range wireless communication device for the same.

The present invention provides an incoming notifying method by which a mobile communication terminal can notify of the incoming through another device by using a profile already defined for short range wireless communication, and the mobile communication terminal and a short range wireless communication device for the same.

The present invention provides an incoming notifying method capable of transmitting an incoming notifying information related to the incoming as well as the notification of the incoming between a mobile communication terminal and a device through a simple encoding and decoding, and the mobile communication terminal and a short range wireless communication device for the same.

In accordance with an aspect of the present invention, a method of notifying of an incoming in a mobile communication terminal is provided. The method includes generating a message having the information exchange format by encoding a message including incoming notifying information related to the incoming to have an information exchange format already defined for short range wireless communication and by adding an incoming notifying parameter set to be in a notification supporting state, when there is the incoming from a mobile communication network; and transmitting the message to a short range wireless communication device set as an incoming notifying device through the short range wireless communication.

In accordance with another aspect of the present invention, a method of notifying of an incoming in a short range wireless communication device is provided. The method includes receiving a message having an information exchange format already defined for short range wireless communication through the short range wireless communication; decoding the message, and checking whether an incoming notifying parameter set to be in a notification supporting state is included in the message and whether a transmission device having transmitted the message is set as a notification-of-incoming transmitting device; and displaying information decoded from the message as incoming notifying information by an incoming notifying popup, when the incoming notifying parameter is set to be in the notification supporting state and the transmission device is set as the notification-of-incoming transmitting device in the message.

In accordance with another aspect of the present invention, a mobile communication terminal is provided. The mobile communication terminal includes a wireless communication unit for providing wireless communication through a mobile communication network; a short range wireless communication unit for transmitting an incoming notifying message to a short range wireless communication device set as an incoming notifying device by short range wireless communication; and a controller for generating a message having the information exchange format by encoding a message including incoming notifying information related to the incoming to have an information exchange format already defined for the short range wireless communication and by adding an incoming notifying parameter set to be in a notification supporting state, and transmitting the message to the short range wireless communication device through the short range wireless communication unit, when there is the incoming from the mobile communication network through the wireless communication unit.

In accordance with another aspect of the present invention, a short range wireless communication device is provided. The short range wireless communication device includes a short range wireless communication unit for receiving a message having an information exchange format already defined for short range wireless communication through the short range wireless communication; a display for displaying incoming notifying information; and a controller for decoding the message, and displaying information decoded from the message as the incoming notifying information through the display by an incoming notifying popup, when an incoming notifying parameter is set to be in a notification supporting state and a transmission device having transmitted the message is set as a notification-of-incoming transmitting device in the message.

### BRIEF DESCRIPTION OF THE DRAWINGS

FIG. 1 is a diagram of a network according to an exemplary embodiment of the present invention;

FIG. 2 is a block diagram of a mobile communication terminal according to the exemplary embodiment of the present invention;

FIG. 3 is a flowchart of processing transmission of an incoming notifying message of the mobile communication terminal according to the exemplary embodiment of the present invention;

FIG. 4 illustrates an example of encoding the incoming-notifying message of the mobile communication terminal according to the exemplary embodiment of the present invention;

FIG. 5 is a block diagram of a short range wireless communication device according to the exemplary embodiment of the present invention;

FIG. 6 is a flowchart of processing reception of the incoming-notifying message of the short range wireless communication device according to the exemplary embodiment of the present invention; and

FIG. 7 illustrates an example of decoding the incoming-notifying message of the short range wireless communication device according to the exemplary embodiment of the present invention.

### DETAILED DESCRIPTION

Hereinafter, various exemplary embodiments of the present invention will be described with reference to the accompanying drawings. In the following description, the same elements will be designated by the same reference numerals although they are shown in different drawings. The following description using the reference numerals of the accompanying drawings is for assistance of general understanding of the embodiments of the present invention as defined by equivalents of the claims. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear. The present invention may, however, be embodied in many different forms and should not be construed as limited to the exemplary embodiments set forth herein. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

Furthermore, although the drawings represent exemplary embodiments of the invention, the drawings are not necessarily to scale and certain features may be exaggerated or omitted in order to more clearly illustrate and explain the present invention.

Terms and words used in the following description and the claims are not limited to their dictionary definitions, and are used by the inventor only for clear and consistent understanding of the present invention. Therefore, the definitions should be made based on contents throughout the specification.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet Personal Computer (PC), a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among the terms set forth herein, data refers to any kind of information processed by the device, including text and/or images received from any external entities, messages transmitted or received, and information created when a specific function is executed by the device.

Among the terms set forth herein, incoming refers to an incoming communication, such as an incoming call or message.

Hereinafter, it will be described that a notification-of-incoming transmitting device and an incoming notifying device are mobile communication terminals as example devices used in the exemplary embodiments of the present invention. However, the exemplary embodiments of the present invention may be applied to other known devices having a similar technical background. Further, the exemplary embodiments of the present invention may be applied to other known devices through some modifications by those skilled in the art without departing from the scope of the present invention. That is, the present invention may be applied to any known device, which is not the mobile communication terminal as long as the device can notify of the incoming through the short range wireless communication.

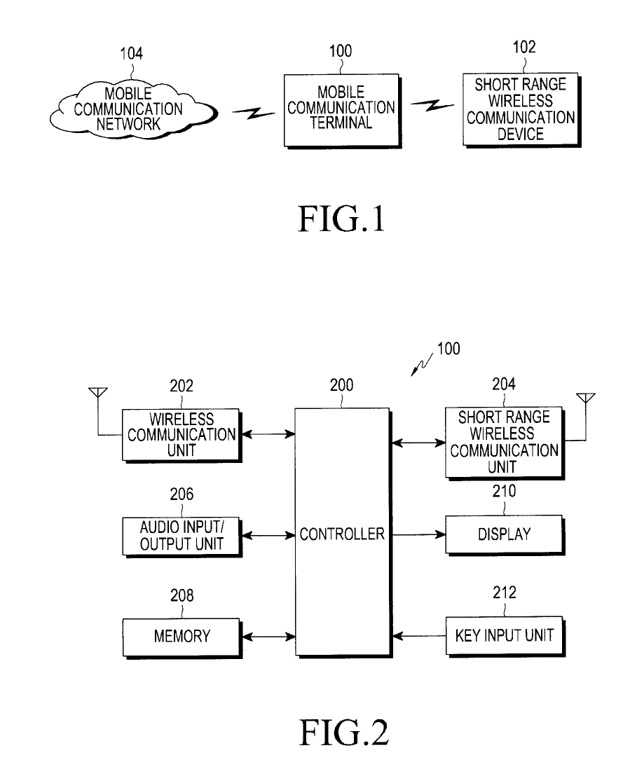

FIG. 1 is a diagram of a network according to the exemplary embodiment of the present invention. Referring to FIG. 1, when there is incoming from a mobile communication network 104, a mobile communication terminal 100 sets a message having an information exchange format already defined for short range wireless communication in a predetermined format and/or communication protocol as an incoming notifying message, and transmits the incoming notifying message to a short range wireless communication device 102 set as an incoming notifying device through the short range wireless communication. When the short range wireless communication device 102 receives the message having the information exchange format set as the incoming notifying message from the mobile communication terminal 100 set as the notification-of-incoming transmitting device through the short range wireless communication, the short range wireless communication device 102 notifies a user of the incoming.

The mobile communication terminal 100 may be one of various types of devices supporting mobile communication and short range wireless communication, for example, a mobile phone, a tablet phone, and a handheld smart phone. The short range wireless communication device 102 may be another mobile communication terminal supporting the short range wireless communication other than the mobile communication terminal 100. For example, the mobile communication terminal 100 may be the tablet phone, and the short range wireless communication device 102 may be the handheld smart phone. The short range wireless communication device 102 may be a fixed device such as a desktop computer among various known types of devices supporting the short range wireless communication, and may be one of any known mobile devices such as a laptop computer, a tablet computer, a digital camera, a PDA, and a PMP. In addition, the short range wireless communication device 102 may be an earpiece and/or a headset.

The short range wireless communication may use and be compliant or compatible with, for example, one of any known communication methods and/or protocols, such as Bluetooth, Ultra Wideband (UWB), Zigbee, Wi-Fi, and Infrared Data Association (IrDA). The information exchange format may be, for example, one of a vCard format, a vCalender format, a vMessage format, and a vNote format. The vCard and vCalender formats are formats defined by the Internet Mail Consortium (IMC), and the vCard format defines an electronic business card and the vCalender defines an input of a personal calendar and schedule management. The vMessage and vNote formats are formats defined by the Infrared Mobile Communication (IrMC) standard, the vMessage format defines a message and the vNote format defines a note.

In a description of the exemplary embodiment of the present invention which will be discussed in greater detail below, the mobile communication terminal 100 and the short range wireless communication device 102 use Bluetooth communication as the short range wireless communication method, and the vNote format of an Object Push Profile (OPP) complying with a Bluetooth standard is used as the information exchange format, as an example. Further, the short range wireless communication device 102 is another type of mobile communication terminal other than the mobile communication terminal 100, as an example. In this case, the mobile communication terminal 100 may be a tablet phone, and the short range wireless communication device 102 may be a handheld smart phone.

In order to notify of the incoming according to the exemplary embodiment of the present invention, the user sets the mobile communication terminal 100 as the notification-of-incoming transmitting device in the short range wireless communication device 102, and sets the short range wireless communication device 102 as the incoming notifying device in the mobile communication terminal 100. In an illustrative example, a plurality of Bluetooth devices may be located near the mobile communication terminal 100 The user selects the short range wireless communication device 102 which, for example, is a Bluetooth device to be used for notifying of the incoming from Bluetooth devices paired with the mobile communication terminal 100, and sets the selected short range wireless communication device 102 as the incoming notifying device. Further, the user selects the mobile communication terminal 100 which is, for example, a Bluetooth device to be used for transmitting the notification of the incoming from Bluetooth devices paired with the short range wireless communication device 102, and sets the selected mobile communication terminal 100 as the notification-of-incoming transmitting device. For example, the user may select and set each of the notification-of-incoming transmitting device and the incoming notifying device in a pairing list menu provided by and output by each of the mobile communication terminal 100 and the short range wireless communication device 102, for example, shown on a displayed menu to the user.

For another example, the mobile communication terminal 100 and the short range wireless communication device 102 may be set as the notification-of-incoming transmitting device and the incoming notifying device, respectively, by transmitting a vNote message to the short range wireless communication device 102 which is one of the Bluetooth devices paired with the mobile communication terminal 100 through the mobile communication terminal 100 by the user. In this case, the mobile communication terminal 100 and the short range wireless communication device 102 may be automatically set as the notification-of-incoming transmitting device or the incoming notifying device based on an address and a name of the counterpart device identified during a process of transmitting and receiving the vNote message between the mobile communication terminal 100 and the short range wireless communication device 102.

FIG. 2 is a block diagram of the mobile communication terminal 100 according to the exemplary embodiment of the present invention. Referring to FIG. 2, the mobile communication terminal 100 includes a controller 200, a wireless communication unit 202, a short range wireless communication unit 204, an audio input/output unit 206, a memory 208, a display 210, and a key input unit 212.

The wireless communication unit 202 transmits and receives a wireless signal for a mobile communication function of the mobile communication terminal 100 through the mobile communication network 104 under a control of the controller 200. The short range wireless communication unit 204 performs Bluetooth communication with Bluetooth devices including the short range wireless communication device 102 located near the mobile communication terminal 100 under the control of the controller 200. The short range wireless communication unit 204 receives a vNote message set as an incoming notifying message from the controller 200, and transmits the vNote message to the short range wireless communication device 102 through the OPP of Bluetooth communication.

The audio input/output unit 206 inputs and outputs various audio signals according to an operation of the controller 200. The memory 208 stores a program for the operation of the controller 200, and stores various types of data according to the operation of the controller 200. The memory 208 may further include an external memory, and also include a storage device such as a Hard Disk Drive (HDD). The display 210 displays an image according to the operation of the controller 200. The key input unit 212 provides various types of key inputs from the user to the controller 200 required for an operation of the mobile communication terminal 100. The key input unit 212 may include a touch screen panel installed on or incorporated into the display 210, and also include keys for inputting numerical, symbolic, and/or character information and functional keys for setting various functions. The controller 200 performs a control for a general function of the mobile communication terminal 100.

Further, when there is the incoming from the mobile communication network 104 through the wireless communication unit 202, the controller 200 generates the vNote message corresponding to a message having the vNote format by encoding a message including incoming notifying information related to the incoming to have the vNote format. In the incoming of a call, the incoming notifying information may include a phone number of a caller. When the phone number of the caller and a name corresponding to the phone number are registered in a phone number book stored in the memory 208, the incoming notifying information may further include the name of the caller. In the incoming of a message, the incoming notifying information may further include a message title other than the phone number and name of the caller.

When the controller 200 encodes the message including the incoming notifying information, the controller 200 generates the vNote message set as the incoming notifying message by adding an incoming notifying parameter set to be in a notification supporting state. The controller 200 transmits the vNote message set as the incoming notifying message to the short range wireless communication device 102 set as the incoming notifying device by the short range wireless communication unit 204.

As described above, in order to set the vNote message as the incoming notifying message and encode the vNote message, the incoming notifying parameter is added to a vNote structure body in the incoming notifying message as shown in an example in Table 1, with the coding, for example, in the C programming language.

TABLE 1
#if defined(_SEC_BT_NOTIFICATION_)
typedef struct
{
VITEM_VEVENT_TYPE type;

| | |
|---|---|
| CHAR | dcreated[VNOTE_MAX_DATETIME_SIZE+1]; |
| CHAR | |

Last_Modified[VNOTE_MAX_DATETIME_SIZE+1];

| | |
|---|---|
| CHAR | summary[VNOTE_MAX_SUMMARY_SIZE*3+1]; |
| vNote_body_t | body; |
| CLASS_TYPE | private_class; |

| | |
|---|---|
| BT_NOTI_TYPE | bt_Noti_Support;//add a parameter for BT Noti |

to the vNote structure body
} vitem_vnote_t;
#endif

In Table 1 above, bt_Noti_Support is the incoming notifying parameter added according to the exemplary embodiment of the present invention. The incoming notifying parameter may be set to be in one of BT_NOTI_SUPPORT corresponding to the notification supporting state and BT_NOTI_NOTSUPPORT corresponding to a notification non-supporting state. When the incoming notifying parameter is set to be in the notification supporting state, the vNote message is set as the incoming notifying message. When the incoming notifying parameter is set to be in the notification non-supporting state, the vNote message is set as the general vNote message irrelevant to the notification of the incoming.

In order to discriminate the incoming notifying message by the incoming notifying parameter, a value of the parameter enum is defined as shown in the example of Table 2, macros are defined as shown in the example of Table 3, and arrays are defined as shown in the example of Table 4, with the coding in Tables 2-4 being, for example, in the C programming language.

TABLE 2

```
#if defined(_SEC_BT_NOTIFICATION_)
typedef enum
{
  B_NOTI_SUPPORT,
  B_NOTI_NOTSUPPORT,
  MAX_BT_NOTI_TYPE
} BT_NOTI_TYPE;
#endif
```

TABLE 3

#if defined(_SEC_BT_NOTIFICATION_)
#define BT_NOTI_SUPPORT 1
#define BT_NOTI_NOTSUPPORT 2
#define S_CAT_BT_NOTI “X-SAMSUNG-BT-NOTI:”
#endif

TABLE 4

```
#if defined(_SEC_BT_NOTIFICATION_)
vitem_tag_t VNOTE_BT_NOTI_TAG[ ] = {
            {“SUPPORT”, BT_NOTI_SUPPORT },
            {“NOTSUPPORT” ,
BT_NOTI_NOTSUPPORT },
            {0,0}
            };
#endif
vitem_tag_t VNOTE_TAG[ ] = {
        {“BEGIN”,VNOTE_TAG_BEGIN },
        {“DCREATED”, VNOTE_TAG_DCREATED},
        {“LAST-MODIFIED”,
VNOTE_TAG_LAST_MODIFIED},
        {“SUMMARY”,VNOTE_TAG_SUMMARY },
        {“BODY”,VNOTE_TAG_BODY },
        {“CATEGORIES”,VNOTE_TAG_CATEGORIES },
        {“CLASS”,VNOTE_TAG_CLASS },
#if defined(_SEC_BT_NOTIFICATION_)
        {“X-SAMSUNG-BT-
NOTI”,VNOTE_TAG_BT_NOTI },
#endif
        {“END” ,VNOTE_TAG_END },
        {0,0}
#if defined(_SEC_BT_NOTIFICATION_)
#define S_CAT_NOTI “X-SAMSUNG-BT-NOTI:”
#endif
```

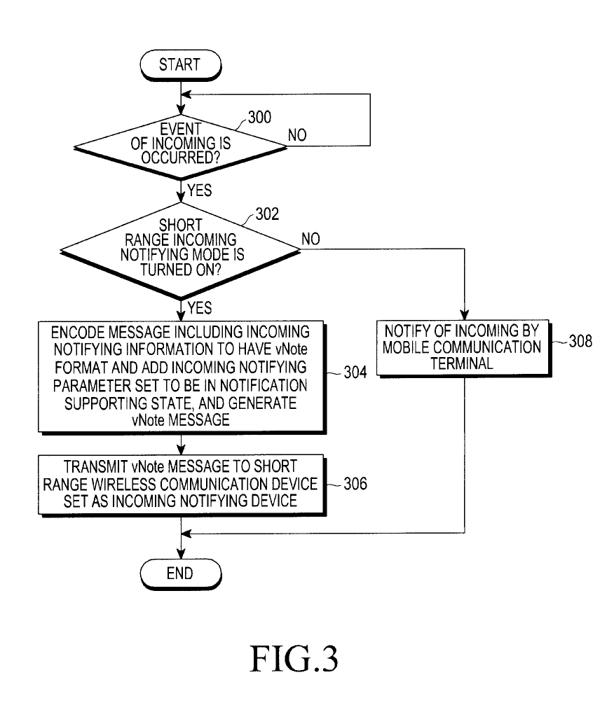

FIG. 3 is a flowchart of processing transmission of an incoming notifying message of the mobile communication terminal according to the exemplary embodiment of the present invention. Referring to FIG. 3, the controller 200 of the mobile communication terminal 100 performs step 302 when an event of the incoming is detected to have occurred in step 300; otherwise, if no event has occurred in step 300, the method loops back and repeats step 300 until an event is detected. The event of the incoming occurs according the incoming of a call or a message from the mobile communication network 104 through the wireless communication unit 202. In step 302, the controller 200 checks whether a short range incoming notifying mode is turned on, for example, by entry of corresponding inputs through the key input unit 212 and/or a touch screen or panel of the display 210, in a manner known in the art. The short range incoming notifying mode is a mode for providing the notification of the incoming through short range wireless communication, and is turned on or off by the user through a menu, an icon and the like similar to general user setting modes which can be turned on or off by the user, in a manner known in the art using a displayed menu, icon or other windows or information displayed in the display 210 in the mobile communication terminal 100 in FIGS. 1-2. When there is the incoming in the mobile communication terminal 100, the user turns on the short range incoming notifying mode when desiring to receive the notification of the incoming through the short range wireless communication device 102. Otherwise, the user turns off the short range incoming notifying mode.

When the short range incoming notifying mode is turned off, as checked in step 302, the controller 200 performs the general notification of the incoming, that is, notifies of the incoming by the mobile communication terminal 100 in step 308. The method in FIG. 3 then ends.

On the other hand, when the short range incoming notifying mode is turned on, as checked in step 302, the controller 200 generates the vNote message in step 304 by encoding the vNote message including the incoming notifying information to have the vNote format. As described above, when the message including the incoming notifying information is encoded, the controller 200 generates the vNote message set as the incoming notifying message by adding the incoming notifying parameter set to be in the notification supporting state.

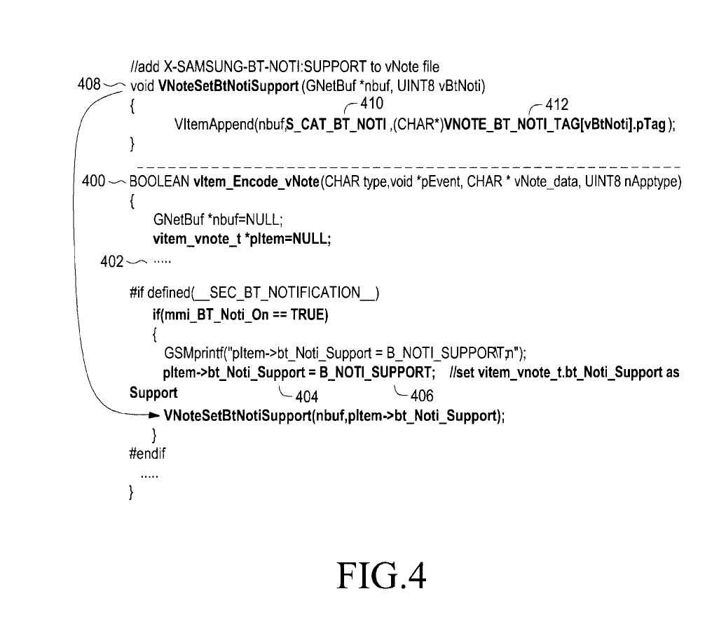

FIG. 4 illustrates an example of an incoming notifying message encoding procedure of the mobile communication terminal according to the exemplary embodiment of the present invention. An encoding according to FIG. 4 shown, for example, in the C programming language, is performed by the controller 200. Referring to FIG. 4, creation of the vNote message is started by a function 400, and the incoming notifying information is included as a memo placed in the location 402. Further, the value of enum shown in Table 2 of BT_NOTE_TYPE shown in Table 1 is input as a parameter and then processed. Accordingly, bt_Noti_Support 404 corresponding to the incoming notifying parameter is set to B_NOTI_SUPPPORT 406 corresponding to the value of enum. Moreover, a field for the notification of the incoming is added by a function 408, that is, S_CAT_BTNOTI 410 and VNOTE_BT_NOTI_TAG 412 shown in Table 4 are added. As described above, as the incoming notifying parameter is set to be in the notification supporting state, the vNote message generated though the encoding as shown in Table 4 is set as the incoming notifying message.

Referring back to FIG. 3, the controller 200 transmits the vNote message set as the incoming notifying message to the short range wireless communication device 102 set as the incoming notifying device by the short range wireless communication unit 204 as described above in step 306. The short range wireless communication unit 204 transmits the vNote message set as the incoming notifying message to the short range wireless communication device 102 through the OPP complying with the Bluetooth standard. The method in FIG. 3 then ends.

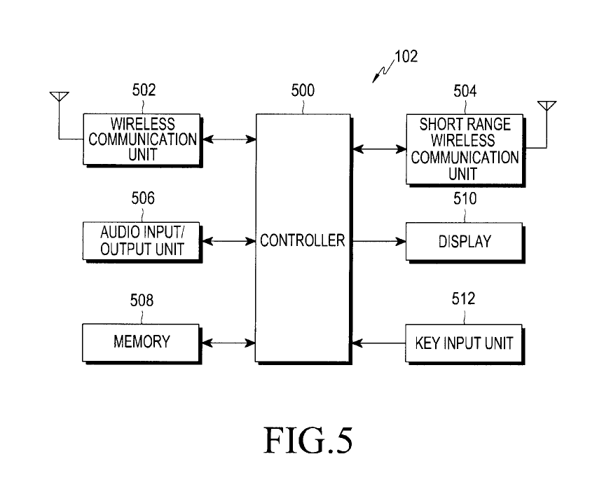

FIG. 5 is a block diagram of the short range wireless communication device according to the exemplary embodiment of the present invention. FIG. 5 illustrates that the short range wireless communication device 102 is the mobile communication terminal as an example as described above. Referring to FIG. 5, the short range wireless communication device 102 includes a controller 500, a wireless communication unit 502, a short range wireless communication unit 504, an audio input/output unit 506, a memory 508, a display 510, and a key input unit 512.

The wireless communication unit 502 transmits and receives a wireless signal for the mobile communication function of the short range wireless communication device 102 through the mobile communication network 104 under a control of the controller 500. The short range wireless communication unit 504 performs Bluetooth communication with Bluetooth devices including the mobile communication terminal 100 located near the short range wireless communication device 102 under the control of the controller 500. The short range wireless communication unit 504 receives the vNote message from the mobile communication terminal 100 through the short range wireless communication.

The audio input/output unit 506 inputs and outputs various audio signals according to an operation of the controller 500. The memory 508 stores a program for the operation of the controller 500, and stores various types of data according to the operation of the controller 500. The memory 508 may further include an external memory, and also include a storage device such as a Hard Disk Drive (HDD). The display 510 displays an image according to the operation of the controller 200. The display 510 displays the incoming notifying information under the control of the controller 500. The key input unit 512 provides various types of key inputs from the user to the controller 500 required for an operation of the short range wireless communication device 102. The key input unit 512 may include a touch screen panel installed on or incorporated in the display 510, and also include keys for inputting numerical, symbolic, and/or character information and functional keys for setting various functions. The controller 500 performs a control for a general function of the short range wireless communication device 102.

Further, the controller 500 decodes the vNote message received from the mobile communication terminal 100 through the short range wireless communication unit 504. When the vNote message includes the incoming notifying parameter set to be in the notification supporting state and the mobile communication terminal 100 corresponding to a transmission device which has transmitted the vNote message is set as the notification-of-incoming transmitting device, information decoded from the vNote message is displayed as the incoming notifying information through the display 510 by an incoming notifying popup.

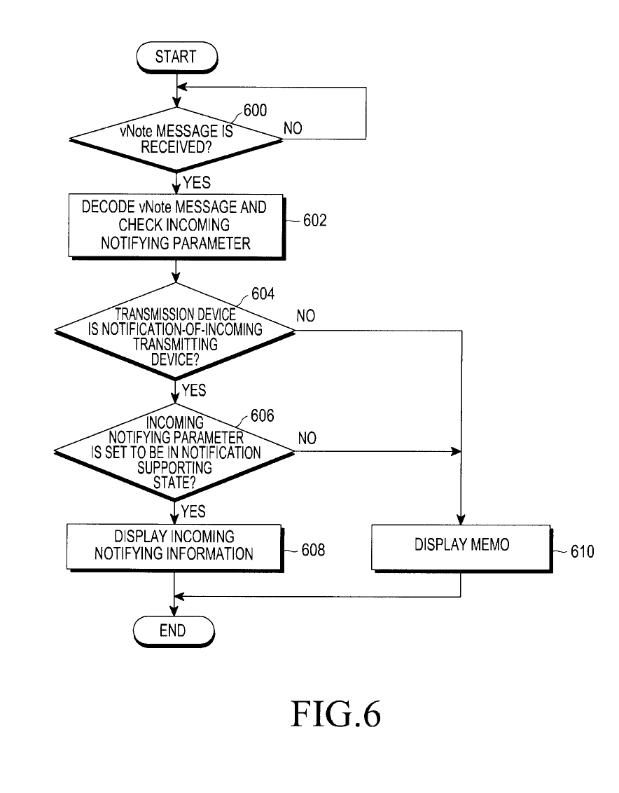

FIG. 6 is a flowchart of processing the reception of an incoming notifying message of the short range wireless communication device according to the exemplary embodiment of the present invention. Referring to FIG. 6, the controller 500 of the short range wireless communication device 102 performs step 602 when the vNote message is detected in step 600 to have been received through the short range wireless communication unit 504; otherwise, the method loops back to repeat step 600 until a vNote message is received. In step 602, the controller 500 decodes the vNote message and checks the incoming notifying parameter.

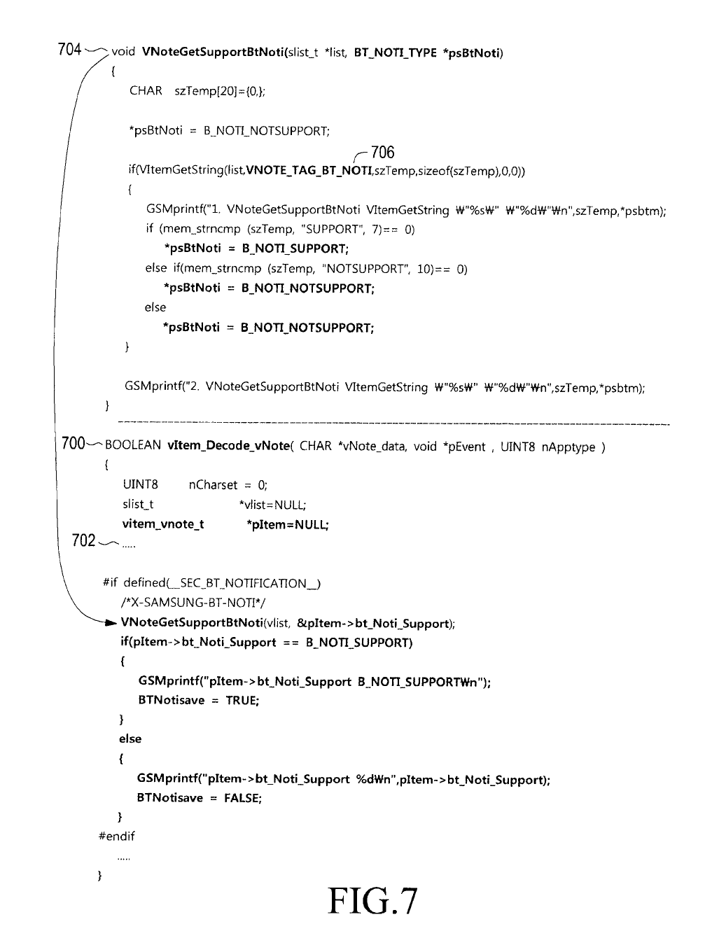

FIG. 7 illustrates an example of decoding an incoming notifying message of the short range wireless communication device according to the exemplary embodiment of the present invention. A decoding according to FIG. 7 shown, for example, in the C programming language, is performed by the controller 500. Referring to FIG. 7, the vNote message is parsed by a function 700, and information included as a memo placed in the location 702 is decoded. Further, it is identified whether the vNote message is set as the incoming notifying message by a function 704. At this time, it is identified whether there is VNOTE_TAG_BT_NOTI 706, that is, X-SAMSUNG-BT-NOTI shown in Table 4, and it is checked whether B_NOTI_SUPPORT or B_NOTI_NOTSUPPORT is set and then taken as the parameter by the function 700.

Referring back to FIG. 6, the controller 500 decodes the vNote message in step 602, and then checks in step 604 whether the transmission device having transmitted the vNote message is set as the notification-of-incoming transmitting device as described above. When the transmission device is the mobile communication terminal 100 set as the notification-of-incoming transmitting device, the controller 500 performs step 606; otherwise, the method proceeds to step 610.

In step 606, the controller 500 checks whether the vNote message is a message set as the incoming notifying message by checking whether bt_Noti_Support corresponding to the incoming notifying parameter is set to be in B_NOTI_SUPPPORT corresponding to the notification supporting state from a result of the decoding. When the incoming notifying parameter is set to be in the notification supporting state, the controller 500 performs step 608; otherwise, the method proceeds to step 610.

In step 608, the controller 500 displays decoded information as the incoming notifying information, as a memo in the location 702 in FIG. 7 through the display 510 using an incoming notifying popup. Accordingly, the user views an incoming notifying popup screen to receive and recognize the notification of the incoming. The method of FIG. 6 then ends.

As described above, it is possible to notify of the incoming through the short range wireless communication device 102 by using the already defined OPP by setting the message as the incoming notifying message by adding the incoming notifying parameter to the message having the already defined vNote format. Further, it is possible to transmit the incoming notifying information related to the incoming as well as the notification of the incoming between the mobile communication terminal 100 and the short range wireless communication device 102 through a simple encoding and decoding by encoding the incoming notifying information to have the vNote format and adding the incoming notifying parameter.

Meanwhile, when the transmission device is not the short range wireless communication device 102 set as the notification-of-incoming transmitting device in step 604 or when the incoming notifying parameter is set to be in the notification non-supporting state in step 606, the controller 500 displays the decoded information as the memo 702 in step 610 similar to a case of receiving the general vNote message.

For reference, the original vNote message and the vNote message set as the incoming notifying message according to the exemplary embodiment of the present invention are compared in an extensible Markup Language (XML) type file as shown in an example in Table 5.

TABLE 5

| | |
|---|---|
| Original | ============= [OPP Trace |
| vNote | vNote]================= |
| | BEGIN:VNOTE |
| | VERSION:1.1 |
| | DCREATED:20000111T024700 |
| | BODY;ENCODING=QUOTED- |
| | PRINTABLE;CHARSET=UTF-8:Hello |
| | CATEGORIES:MISCELLANEOUS |
| | CLASS:PUBLIC |
| | END:VNOTE |
| | ========================================== |
| | == |
| Incoming | ============= [OPP Trace |
| notifying | vNote]================= |
| vNote | BEGIN:VNOTE |
| | VERSION:1.1 |
| | DCREATED:20000111T024200 |
| | BODY;ENCODING=QUOTED- |
| | PRINTABLE;CHARSET=UTF-8:Hello |
| | CATEGORIES:MISCELLANEOUS |
| | CLASS:PUBLIC |
| | X-SAMSUNG-BT-NOTI:SUPPORT |
| | END:VNOTE |
| | ========================================== |
| | ===== |

As described, according to the present invention, the mobile communication terminal can notify the user of the incoming through another device by using a profile already defined for the short range wireless communication in a predetermined format and/or communication protocol by adding the incoming notifying parameter to the message having the information exchange format already defined for the short range wireless communication in the predetermined format and/or communication protocol. Further, the mobile communication terminal can transmit the incoming notifying information related to the incoming as well as the notification of the incoming between the mobile communication terminal and the short range wireless communication device through a simple encoding and decoding by encoding the incoming notifying information to have the vNote format by adding the incoming notifying parameter.

Meanwhile, although the present invention has been described with reference to the detailed exemplary embodiments, the present invention may include various modifications without departing the scope of the present invention. For example, it has been described that the Bluetooth communication technology may be used as an example of the short range wireless communication in the exemplary embodiments of the present invention, but different types of short range wireless communication such as UWB, Zigbee, Wi-Fi, and IrDA may be used. Further, it has been described that the vNote format is used as the information exchange format as an example, but other information exchange formats such as the vCard format, the vCalender format, and the vMessage format may be used. In addition, it has been described that the incoming notifying message is transmitted and received through the OPP as an example, but other profiles corresponding to the short range wireless communication mode and the information exchange format may be used.

The above-described apparatus and methods according to the present invention can be implemented in hardware, firmware or as software or computer code that can be stored in a non-transitory recording medium such as a Compact Disc Read Only Memory (CD ROM), a Random Access Memory (RAM), a Read Only Memory (ROM), a floppy disk, Digital Versatile Discs (DVDs), a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an Application Specific Integrated Circuit (ASIC) or Field-Programmable Gate Array (FPGA). As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any medium such as communication signals transmitted by wire/wireless connections, and their equivalents. The computer readable recording medium can also be distributed in network coupled computer systems so that the computer readable code is stored and executed in a distributed fashion.

In addition, when the incoming notifying method according to the exemplary embodiments of the present invention is applied to the mobile device, the mobile device can use a program, for example, an application, for the notification of the incoming in notifying a user of the incoming by downloading the program from a remotely located program providing device, for example, a server, or installing and executing the program. That is, when the program for the notification of the incoming is installed in the mobile device, the program is executed in the mobile device and then the notification of the incoming may be provided. The program providing device transmits the program to the mobile device automatically or in response to a request for transmission of the program. At this time, the program providing device may further determine whether the mobile device subscribes to a service and identify a user authentication and payment information. The program providing device may include a communication unit for performing wired or wireless communication with the mobile device, a storage medium for storing the program, and a controller for transmitting the program to the mobile device by the communication unit. The storage medium may be located inside or outside of the program providing device.

Therefore, the scope of the present invention should be defined by equivalents of the claims as well as the claims, but is not limited to the above described embodiments.

What is claimed is:

1. A method of notifying of an incoming in a mobile communication terminal, the method comprising:
generating a message having a predetermined information exchange format for short range wireless communication by encoding a message including incoming notifying information related to the incoming to have the predetermined information exchange format and by adding an incoming notifying parameter to the message, with the incoming notifying parameter set to be in a notification supporting state when there is the incoming from a mobile communication network; and
transmitting the message to a short range wireless communication device set as an incoming notifying device through the short range wireless communication.

2. The method of claim 1, the predetermined information exchange format is one of a vCard format, a vCalender format, a vMessage format, and a vNote format.

3. The method of claim 1, wherein the predetermined information exchange format is a vNote format, and the incoming notifying parameter is added to a vNote structure body.

4. The method of claim 3, wherein the short range wireless communication is a BLUETOOTH-compliant communication, and the transmitting of the message comprises transmitting the message through an Object Push Profile (OPP).

5. A method of notifying of an incoming in a short range wireless communication device, the method comprising:
receiving, through a short range wireless communication, a message having a predetermined information exchange format for short range wireless communication;
decoding the message, and checking whether an incoming notifying parameter set to be in a notification supporting state is included in the message and whether a transmission device having transmitted the message is set as a notification-of-incoming transmitting device; and
displaying information decoded from the message as incoming notifying information by an incoming notifying popup, when the incoming notifying parameter is set to be in the notification supporting state and the transmission device is set as the notification-of-incoming transmitting device in the message.

6. The method of claim 5, wherein the predetermined information exchange format is one of a vCard format, a vCalender format, a vMessage format, and a vNote format.

7. The method of claim 5, wherein the predetermined information exchange format is a vNote format, and the incoming notifying parameter is added to a vNote structure body.

8. The method of claim 7, wherein the short range wireless communication is a BLUETOOTH-compliant communication, and the receiving of the message comprises receiving the message through an Object Push Profile (OPP).

9. A mobile communication terminal comprising:
a wireless communication unit for providing wireless communication through a mobile communication network;
a short range wireless communication unit for transmitting an incoming notifying message to a short range wireless communication device set as an incoming notifying device by short range wireless communication; and
a controller for generating a message having a predetermined information exchange format for short range wireless communication by encoding a message including incoming notifying information related to an incoming to have the information exchange format and by adding an incoming notifying parameter to the message, with the incoming notifying parameter set to be in a notification supporting state, and transmitting the message to the short range wireless communication device through the short range wireless communication unit, when there is the incoming from the mobile communication network through the wireless communication unit.

10. The mobile communication terminal of claim 9, wherein the predetermined information exchange format is one of a vCard format, a vCalender format, a vMessage format, and a vNote format.

11. The mobile communication terminal of claim 9, wherein the predetermined information exchange format is a vNote format, and the incoming notifying parameter is added to a vNote structure body.

12. The mobile communication terminal of claim 11, wherein the short range wireless communication unit is a BLUETOOTH-compliant communication unit, and the message is transmitted through an Object Push Profile (OPP).

13. A short range wireless communication device comprising:
a short range wireless communication unit for receiving, through a short range wireless communication, a message having a predetermined information exchange format for short range wireless communication;
a display for displaying incoming notifying information; and
a controller for decoding the message, and displaying information decoded from the message as the incoming notifying information through the display by an incoming notifying popup, when an incoming notifying parameter is set to be in a notification supporting state and a transmission device having transmitted the message is set as a notification-of-incoming transmitting device in the message.

14. The short range wireless communication device of claim 13, wherein the predetermined information exchange format is one of a vCard format, a vCalender format, a vMessage format, and a vNote format.

15. The short range wireless communication device of claim 14, wherein the predetermined information exchange format is the vNote format, and the incoming notifying parameter is added to a vNote structure body.

16. The short range wireless communication device of claim 15, wherein the short range wireless communication unit is a BLUETOOTH-compliant communication unit, and the message is received through an Object Push Profile (OPP).
